(19) United States
(12) Patent Application Publication
(10) Pub. No.: US 2014/0267020 A1
(43) Pub. Date: Sep. 18, 2014

(54) WRIST TERMINAL DEVICE, COMMUNICATIONS TERMINAL DEVICE, TERMINAL DEVICE, DISPLAY CONTROL METHOD OF TERMINAL DEVICE, AND STORAGE MEDIUM STORING DISPLAY CONTROL PROGRAM

(71) Applicant: CASIO COMPUTER CO., LTD., Tokyo (JP)

(72) Inventor: Jumpei ISHIBASHI, Tokyo (JP)

(73) Assignee: CASIO COMPUTER CO., LTD., Tokyo (JP)

(21) Appl. No.: 14/207,218

(22) Filed: Mar. 12, 2014

(30) Foreign Application Priority Data
Mar. 13, 2013 (JP) 2013-050081

(51) Int. Cl. G06F 3/01

(52) U.S. Cl. CPC G06F 3/014
USPC 345/156

(57) ABSTRACT

A wrist terminal device is configured to be worn around a wrist of a user. The device includes a motion state detecting unit, a receiving unit, a display unit and a motion-responsive display control unit. The motion state detecting unit detects a motion state of the user. The receiving unit receives mail arrival notification and an e-mail from a communications terminal device. The display unit displays the e-mail received by the receiving unit. The motion-responsive display control unit controls the display unit to display the received e-mail in a display style according to the motion state of the user detected by the motion state detecting unit in response to the receiving unit receiving the mail arrival notification and the e-mail.

### CROSS REFERENCE TO RELATED APPLICATION

This application is based upon and claims the benefit of priority under 35 USC 119 of Japanese Patent Application No. 2013-050081 filed on Mar. 13, 2013, the entire disclosure of which, including the description, claims, drawings and abstract, is incorporated herein by reference in its entirety.

### BACKGROUND OF THE INVENTION

1. Field of the Invention

The present invention relates to a wrist terminal device, a communications terminal device, a terminal device, a display control method of a terminal device, and a storage medium storing a display control program.

2. Description of the Related Art

In earlier development, there have been a system including a communications terminal device such as mobile phone and a wrist terminal device that are capable of performing data communication with each other by means of near field communication such as wireless communication, e.g. Bluetooth (registered trademark). When there is an incoming call, an incoming e-mail or the like on the mobile phone, the incoming information is sent from the mobile phone to the wrist terminal device, and the wrist terminal device vibrates to notify a user of the incoming information. For example, Patent Document 1 (JP 2002-223475A) describes a system in which the text of an incoming e-mail that a mobile phone has received is displayed on a wrist terminal device. Further, Patent Document 2 (JP 2010-021902A) describes a system in which when there is an incoming e-mail on a mobile phone, a wrist terminal device makes an incoming notification. The system can display the e-mail, ignore the e-mail or reply a pre-fixed message according to a twist motion or a vertical or horizontal motion of the hand wearing the wrist terminal device.

However, the above-described wrist terminal devices require a gesture to instruct operations such as displaying the e-mail or replying a pre-fixed message at the time of receiving an e-mail. Further, if a user is on the move such as by jogging for example, the user cannot readily check the text of the e-mail without stopping the jogging because the full text of the e-mail is displayed in small letters. For these reasons, the wrist terminal devices of earlier development cannot display a received e-mail in a suitable display style according to the motion state of a user.

### SUMMARY OF THE INVENTION

It is an object of the present invention to provide a wrist terminal device, a communications terminal device, a terminal device and the like that can display received information in a suitable display style according to the motion state of a user without requiring any operation by the user.

In order to achieve at least one of the objects, according to a first aspect of the present invention, there is provided a wrist terminal device configured to be worn around a wrist of a user, including a motion state detecting unit which detects a motion state of the user, a receiving unit which receives message arrival notification and a message from a communications terminal device, a display unit which displays the message received by the receiving unit and a motion-responsive display control unit which controls the display unit to display the received message in a display style according to the motion state of the user detected by the motion state detecting unit in response to the receiving unit receiving the message arrival notification and the message.

According to a second aspect of the present invention, there is provided a terminal device configured to be worn by a user, including an information receiving unit which receives information from a communications terminal device a motion state detecting unit which detects a motion state of the user, a display unit which displays the information received from the communications terminal device, a first-motion display control unit which controls the display unit to display a part of the received information according to a first motion state of the user detected by the motion state detecting unit, a second-motion display control unit which controls the display unit to stop displaying the received information according to a second motion state of the user detected by the motion state detecting unit, after the control of the first-motion display control unit is performed, and

an undisplay identifier sending unit which sends a previously displayed part of the received information to the communications terminal device in a distinguishable manner from an undisplayed part of the e-mail when the control of the second-motion display control unit is performed.

### BRIEF DESCRIPTION OF THE DRAWINGS

FIG. 1 is an external view of a wrist terminal device according to the present invention.

FIG. 2 is a block diagram illustrating a schematic configuration of the wrist terminal device.

FIG. 3 is an external view of a communications terminal device.

FIG. 4 is a block diagram illustrating a schematic configuration of the communications terminal device.

FIG. 5 is a flowchart of a mail display process of the wrist terminal device.

FIG. 6 is a flowchart of a user state-responsive mail display process of the wrist terminal device.

FIG. 7 is a flowchart of a mail display process of the communications terminal device.

FIG. 8A to FIG. 8I are views illustrating running example 1 of the mail display process of the wrist terminal device and the communications terminal device.

FIG. 9A to FIG. 9H are views illustrating running example 2 of the mail display process in the wrist terminal device and the communications terminal device.

FIG. 10A to FIG. 10G are views illustrating running example 3 of the mail display process in the wrist terminal device and the communications terminal device.

### DETAILED DESCRIPTION OF THE INVENTION

Hereinafter, an exemplary embodiment of the present invention will be described in detail referring to the appended drawings. However, the scope of the present invention is not limited to the illustrated examples.

### (Configuration)

### (Wrist Terminal Device)

FIG. 1 is an external view of a wrist terminal device according to the present invention. FIG. 2 is a block diagram illustrating a schematic configuration of the wrist terminal device.

As illustrated in FIG. 1, the wrist terminal device 1 is in the form of a wrist watch for example and is worn around a user's wrist.

As illustrated in FIG. 2, the wrist terminal device 1 includes a display section 11, an input section 12, a near field communication section 13, an accelerometer 14, a notification section 15, a memory section 16, a CPU 17 and the like.

The display section 11 includes a display 110, and displays various types of information based on display signals input from the CPU 17. The display 110 is, for example, a color liquid crystal display using organic electroluminescence elements or the like. In the embodiment, the display 110 is integrally formed with a touch panel 121, and is capable of receiving user's touch operations.

The input section 12 includes keys 120 and the above-described touch panel 121, and outputs signals corresponding to kinds of pressed keys and positions of the touch panel 121 to the CPU 17.

The near field communication section 13 includes a module for wireless communication format such as Bluetooth (registered trademark). When there is a communications terminal device 2 (described below, see FIG. 3) in the communicable area (e.g. within 2 meters radius), the near field communication section 13 performs wireless communication with the communications terminal device 2.

The accelerometer 14 is a sensor to measure the acceleration acting on the wrist terminal device 1 by resolving it into components in directions of three axes. The accelerometer 14 detects, for example, posture (inclination angle) and motion of the wrist terminal device 1. That is, the accelerometer 14 detects the following states of a user wearing the wrist terminal device 1 around his/her wrist based on a predetermined inclination angle and motion of the wrist terminal device 1: swinging his/her arm, holding up his/her arm to look at the wrist terminal device 1 while staying still, holding up his/her arm to look at the wrist terminal device 1 while on the move, and putting down his/her arm.

The notification section 15 includes a speaker, an LED, a vibrator and the like. In response to receiving an incoming e-mail from the communications terminal device 2, the notification section 15 notifies the user of arrival of the e-mail by means of ringtone (e.g. a melody or a message voice), light, vibration or the like. Further, the notification section 15 audibly outputs the text of the received e-mail so as to inform the user of the content thereof.

The memory section 16 stores programs and data for various functions of the wrist terminal device 1, and also serves as a working area of the CPU 17. In the embodiment, the memory section 16 stores a mail display program 160, incoming mail data 161 and the like.

As described below, the mail display program 160 is a program that makes the CPU 17 detect the motion state of a user upon receiving arrival notification, a mail sender and a mail text of an e-mail from the communications terminal device 2 so as to display the e-mail on the display 110 of the wrist terminal device 1 in a display style according to the motion state. The program also makes the CPU 17 send the mail number, the mail sender, and a previously displayed part of the mail text of the e-mail that was displayed on the wrist terminal device 1 to the communications terminal device 2.

The incoming mail data 161 includes a mail sender, a title, a mail text, a receipt date, a receipt time and the like of an e-mail received from the communications terminal device 2, each of which is connected to a mail number. Regarding the mail text of an incoming e-mail stored as the incoming mail data 161, the previously displayed part that has been already displayed on the display 110 of the wrist terminal device 1 is stored in a distinguishable manner from the undisplayed part.

The CPU 17 controls each component of the wrist terminal device 1 by central controlling. Specifically, the CPU 17 opens a program designated from a system program and various application programs stored in the memory section 16, and performs various processes in cooperation with the opened program.

### (Communications Terminal Device)

FIG. 3 is an external view illustrating the communications terminal device. FIG. 4 is a block diagram illustrating a schematic configuration of the communications terminal device.

The communications terminal device 2 may be a device that is capable of performing near field communication with the wrist terminal device 1, such as a smartphone (see FIG. 3), a mobile phone and a personal computer. In the embodiment, a smartphone is employed.

As illustrated in FIG. 4, the communications terminal device 2 includes a display section 21, an input section 22, a communication section 23, an accelerometer 24, a notification section 25, an imaging section 28, a memory section 26, a CPU 27 and the like.

The display section 21 includes a display 210, and displays various types of information based on display signals input from the CPU 27. The display 210 is, for example, a color liquid crystal display using organic electroluminescence elements or the like. In the embodiment, the display 210 is integrally formed with a touch panel 221 and is capable of receiving user's touch inputs.

The input section 22 includes keys 220 and the above-described touch panel 221, and outputs signals corresponding to kinds of pressed keys and positions of the touch panel 221 to the CPU 27.

The communication section 23 includes a wireless communication section 230 and a near field communication section 231.

The wireless communication section 230 performs data communication with a mail server, for example by wireless communication. The wireless communication method may be mobile communication, wireless LAN such as Wi-Fi, or the like.

The near field communication section 231 includes a module for wireless communication format such as Bluetooth (registered trademark). When there is the wrist terminal device 1 in the communicable area (e.g. within 2 meters radius), the near field communication section 231 performs wireless communication with the wrist terminal device 1.

The accelerometer 24 is a sensor to measure the acceleration acting on the communications terminal device 2 by resolving it into components in directions of three axes. The accelerometer 24 detects motion of the communications terminal device 2 so as to detect whether a user has taken the communications terminal device 2 out of a bag, a pocket or the like.

The notification section 25 includes a speaker, an LED, a vibrator and the like. Upon receiving an incoming e-mail from a mail server, the notification section 25 notifies a user of arrival of the e-mail by means of ringtone (e.g. a melody or a message voice), light, vibration or the like.

The imaging section 28 is a camera composed of a lens, an imaging element and the like, and stores an image that enters through the lens to be focused on the imaging element in the memory section 26 of the CPU 27 as an image signal according to a command from the CPU 27. For example, an image taken by a user is stored in the memory section 26.

Further, the imaging section 28 detects change of the ambient brightness by detecting external light, so as to detect whether the communications terminal device 2 has been taken out of a bag, a pocket or the like. Specifically, if the ambient brightness changes from “dark” to “bright”, it detects that the communications terminal device 2 is taken out of a bag, a pocket or the like. If the ambient brightness changes from “bright” to “dark” on the contrary, it detects that the communications terminal device 2 is put away in a bag, a pocket or the like.

The memory section 26 stores programs and data for various functions of the communications terminal device 2, and also serves as a working area of the CPU 27. In the embodiment, the memory section 26 stores a mail display program 260, an incoming mail data 261 and the like.

As described below, the mail display program 260 is a program that makes the CPU 27 perform the following process: upon receipt of an e-mail from a mail server through wireless communication with a base station, the CPU 27 sends arrival notification, a mail number, a mail sender and a mail text to the wrist terminal device 1 through wireless communication, and then the CPU 27 receives the mail number, the mail sender and a previously displayed part of the mail text of the e-mail that was displayed on the wrist terminal device 1 from the wrist terminal device 1, so as to display the e-mail on the display 210 of the communications terminal device 2 in a manner that distinguishes the displayed part from the undisplayed part of the mail text.

The incoming mail data 261 includes a mail sender, a title, a mail text, a receipt date, a receipt time and the like of an e-mail received from a mail server, each of which is connected to a mail number. Regarding the mail text of an incoming e-mail stored as the incoming mail data 261, the previously displayed part that has been already displayed on the display 110 of the wrist terminal device 1 is distinguishably stored from the undisplayed part.

The CPU 27 controls each component of the communications terminal device 2 by central controlling. Specifically, the CPU 27 opens a program designated from a system program and various application programs stored in the memory section 26, and performs various processes in cooperation with the opened program.

### (Operation)

Next, the mail display process of the wrist terminal device 1 will be described referring to FIG. 5 and FIG. 6.

FIG. 5 is a flowchart of the mail display process of the wrist terminal device, and FIG. 6 is a flowchart of the user's motion state-responsive mail display process of the wrist terminal device.

When the communications terminal device 2 receives an e-mail from a mail server and sends the arrival notification, the mail number, the mail sender and the mail text of the e-mail to the wrist terminal device 1, the CPU 17 of the wrist terminal device 1 receives the arrival notification, the mail number, the mail sender and the mail text (Step S1). The CPU 17 connects the mail sender and the mail text of the received e-mail to the mail number, and stores them in the memory section 16 as the incoming mail data 161.

Next, the CPU 17 performs the user's motion state-responsive mail display process (Step S2).

Specifically, in the user's motion state-responsive mail display process as illustrated in FIG. 6, the CPU 17 firstly makes a determination as to whether Motion State (2) of swinging his/her arm (e.g. motion state of jogging or the like) is detected (Step T1). Specifically, a determination is made as to whether the motion of the wrist terminal device 1 detected by the accelerometer 14 is a motion of the wrist terminal device 1 when the user swings his/her arm.

If Motion State (2) is detected in Step T1 (Step T1: Yes), a mail notification is made by means of a message voice or the like (Step S2), and the process proceeds to Step T4. If Motion State (2) is not detected (Step T1: No), a mail notification is made by means of ringtone (a melody or the like), vibration or the like (Step T3), and the process proceeds to Step T4.

In Step T4, a determination is made as to whether Motion State (1) of the user holding up his/her arm to look at the display 110 while staying still is detected. Specifically, a determination is made as to whether the inclination angle of the wrist terminal device 1 detected by the accelerometer 14 is an inclination angle of the wrist terminal device 1 when the user holds up his/her arm to look at the display 110 while staying still.

If Motion State (1) is detected in Step T4 (Step T4: Yes), the incoming e-mail is read out from the incoming mail data 161, and the mail sender of the incoming mail and an ordinary watch image are displayed respectively on the upper and lower parts of the display 110 (Step T5), and then a determination is made as to whether the user performs a touch operation on the display 110 (Step T6).

If a touch operation is performed in Step T6 (Step T6: Yes), the process proceeds to Step T8 (described below). If a touch operation is not performed (Step T6: No), a determination is made as to whether Motion State (1) is continuously detected for a predetermined period of time (e.g. 3 seconds, or the like) (Step T7).

If Motion State (1) is not continuously detected for a predetermined period of time in Step T7 (Step T7: No), a determination is made as to whether Motion State (4) of the user putting down his/her arm is detected (Step T14). Specifically, a determination is made as to whether the motion of the wrist terminal apparatus 1 detected by the accelerometer 14 is a motion of the wrist terminal apparatus 1 when the user puts down his/her arm.

If Motion State (4) is not detected in Step T14 (Step T14: No), the process proceeds to other processes. If Motion State (4) is detected (Step T14: Yes), the display 110 is turned off (Step T16), and the user's motion state-responsive mail display process ends.

If Motion State (1) is continuously detected for a predetermined period of time in Step T7 (Step T7: Yes), the mail text is displayed on the upper part of the display 110 in a horizontally scrollable manner while an ordinary watch image is displayed on the lower part (Step T8), and then the process proceeds to Step T9.

In Step T9, a determination is made as to whether Motion State (4) of the user putting down his/her arm is detected. If Motion State (4) is not detected (Step T9: No), the process proceeds to Step T8 where the mail text is displayed in a horizontally scrollable manner on the upper part of the display 110 while an ordinary watch image is displayed on the lower part until Motion State (4) is detected.

If Motion State (4) is detected in Step T9 (Step T9: Yes), the display 110 is turned off (stopped) (Step T16), and the user's motion state-responsive mail display process ends.

If Motion State (1) is not detected in Step T4 (Step T4: No), a determination is made as to whether Motion State (3) of the user holding up his/her arm to look at the display 110 while on the move is detected (Step T10). Specifically, a determination is made as to whether the inclination angle of the wrist terminal device 1 detected by the accelerator 14 is an inclination angle of the wrist terminal device 1 when the user holds up his/her arm to look at the display 110 while on the move.

If Motion State (3) is not detected in Step T10 (Step T10: No), the user's motion state-responsive mail display process ends.

If Motion State (3) is detected (Step T10: Yes), the mail sender is displayed on the full screen of the display 110 with letters being enlarged (Step T11), and then a determination is made as to whether Motion State (3) is detected continuously for a predetermined period of time (e.g. 3 seconds, or the like) (Step T12).

If Motion State (3) is not detected continuously for a predetermined period of time in Step T12 (Step T12: No), the process proceeds to the above-described Step T14. If Motion State (3) is detected continuously for a predetermined period of time (Step T12: Yes), the mail text is displayed on the full screen of the display 110 with letters being enlarged, and the displayed content of the mail text is audibly output (Step T13). In this step, if the full text of the mail text cannot be displayed on one screen, it is displayed by a displayable fraction in a switchable manner by vertical scroll.

Next, the CPU 17 makes a determination as to whether Motion State (4) is detected (Step T15). If Motion State (4) is not detected (Step T15: No), the process proceeds to Step T13 where the mail text is displayed on the full screen of the display 110 with letters being enlarged and the displayed content is audibly output until Motion State (4) is detected.

If Motion State (4) is detected in Step T15 (Step T15: Yes), the display 110 is turned off (Step T16), and the user's motion state-responsive mail display process ends.

After the user's motion state-responsive mail display process is complete as described above, the CPU 17 makes a determination as to whether to inform the communications terminal device 2 of the previously displayed part of the e-mail that was displayed on the display 110 of the wrist terminal device 1 as illustrated in FIG. 5 (Step S3).

If the CPU 17 determines not to inform the previously displayed part in Step S3 (Step S3: No), the process proceeds to Step S5. If the CPU 17 determines to inform the previously displayed part (Step S3: Yes), the mail number, the mail sender and the previously displayed part of the previously displayed e-mail are sent to the communications terminal device 2 (Step S4), and then the process proceeds to Step S5.

Next, the CPU 17 makes a determination as to whether Motion State (1) of the user holding up his/her arm to look at the display 110 while staying still is detected (Step S5). If Motion State (1) is not detected (Step S5: No), the mail display process ends.

If Motion State (1) is detected (Step S5: Yes), the continuation of the previously displayed part of the mail text is displayed on the upper part of the display 110 in a horizontally scrollable manner while the ordinary watch image is displayed on the lower part (Step S6), and then a determination is made as to whether Motion State (4) of the user putting down his/her arm is detected (Step S7).

If Motion State (4) is not detected in Step S7 (Step S7: No), the process proceeds to the above-described Step S6. If Motion State (4) is detected (Step S7: Yes), the display 110 is turned off (Step S8), and the process proceeds to the above-described Step S3.

Next, the mail display process of the communications terminal device 2 will be described referring to FIG. 7.

FIG. 7 is a flowchart for describing the mail display process of the communications terminal device.

In communications terminal device 2, the CPU 27 receives an e-mail from a mail server (Step U1), connects the mail sender and the mail text of the received e-mail to the mail number, and stores them in the memory section 26 as the incoming mail data 261. Then, the arrival notification, the mail number, the mail sender and the mail text of the e-mail are sent to the wrist terminal device 1 (Step U2).

Next, the CPU 27 makes a determination as to whether the mail number, the mail sender and the previously displayed part of the mail text of the previously displayed e-mail are received from the wrist terminal device 1 (Step U3). If they are not received (Step U3: No), the mail display process ends.

If the CPU 27 determines that the mail number, the mail sender and the previously displayed part of the mail text of the previously displayed e-mail are received in Step U3 (Step U3: Yes), a determination is made as to whether it is detected that the user takes the communications terminal device 2 out of a pocket, a bag or the like (Step U4). Taking out of the communications terminal device 2 is detected by use of the accelerometer 24 or the imaging section 28 (the internal camera of the communications terminal device 2).

If taking out of the communications terminal device 2 is not detected in Step U4 (Step U4: No), the mail display process ends. If taking out of the communications terminal device 2 is detected (Step U4: Yes), a mail software is launched to display the mail text on the display 210 in a manner that distinguishes the displayed part from the undisplayed part (Step U5), and then the process proceeds to Step U6.

In Step U6, a determination is made as to whether the user operates to exit the mail browsing.

This determination of whether the mail browsing exit operation is performed is made based on power-off of the communications terminal device 2 or launch of a software other than the mail software.

If the mail browsing exit operation is performed (Step U6: Yes), the mail display process ends. If the mail browsing exit operation is not performed (Step U6: No), the process proceeds to Step U5 where the mail text is displayed on the display 210 in the manner that distinguishes the displayed part from the undisplayed part until the mail browsing is finished.

Next, the above-described the mail display processes of the wrist terminal device 1 and the communications terminal device 2 will be described more specifically referring to the drawings.

### Operation Example 1

First, when the communications terminal device 2 receives an e-mail from a mail server (Step U1, FIG. 8A), it sends arrival notification, the mail number, the mail sender and the mail text of the e-mail to the wrist terminal device 1 (Step U2, FIG. 8B). In response, the wrist terminal device 1 receives the arrival notification, the mail number, the mail sender and the mail text of the e-mail (Step S1).

While the user is swinging his/her arm by jogging or the like (Motion State (2) detected) (Step T1: Yes), the mail notification is made by means of a message voice or the like (e.g. a message voice of “You've got a mail from Mr. Sato”) (Step T2, FIG. 8C).

Thereafter, in response to the user holding up his/her arm to look at the wrist terminal device 1 (Motion State (3) detected) (Step T10: Yes), the mail sender (e.g. “Mr. Sato”) is displayed on the full screen of the display 110 with letters being enlarged (Step T11, FIG. 8D).

Then, in response to the user keeping his/her arm up to look at the wrist terminal device 1 for a predetermined period of time while jogging (Motion State (3) continues for the predetermined period of time) (Step T12: Yes), the mail text is displayed on the full screen of the display 110 with letters being enlarged, and the displayed content is audibly output (Step T13, FIG. 8E). For example, “Good morning.” is displayed on the full screen with letters being enlarged, and “Good morning.” is audibly output.

If the mail text cannot be fully displayed on one screen, it is displayed by a displayable fraction in a switchable manner by vertical scroll as illustrated in FIG. 8F. For example, the displayable fractions are “Good morning.”, the following “Regarding the subject of tomorrow's meeting” and so on, which are displayed in a vertically scrollable manner.

Thereafter, in response to the user putting down his/her arm (Motion State (4) detected) (Step T15: Yes), the display 110 is turned off (Step T16, FIG. 8G).

Thereafter, in response to the user taking out the communications terminal device 2 (Step U4: Yes), a mail software is launched to display the mail text of the e-mail that was previously displayed on the wrist terminal device 1 on the display 210 in the manner that distinguishes the displayed part from the undisplayed part (Step U5, FIG. 8H). For example, the previously displayed part “Good morning. Regarding the subjects of tomorrow's meeting, this is just a reminder.” is distinguished from the undisplayed part “The subject of tomorrow's meeting is ABC.” by changing the size or the color of the letters.

After the user has operated to exit browsing on the communications terminal device 2, in response to the user holding up his/her arm to look at the wrist terminal device 1 again while staying still (Motion State (1) detected) (Step S5: Yes), the continuation of the previously displayed part of the mail text is displayed on the upper part of the display 110 in a horizontally scrollable manner while an ordinary watch image is displayed on the lower part (Step S6, FIG. 8I). For example, the following part “It will start at 13 o'clock”, which comes after the previously displayed part “The subject of tomorrow's meeting is ABC.”, is scrolled on the upper part of the display 110.

### Operation Example 2

First, when the communications terminal device 2 receives an e-mail from a mail server (Step U1, FIG. 9A), it sends arrival notification, the mail number, the mail sender and the mail text of the e-mail to the wrist terminal device 1 (Step U2, FIG. 9B). In response, the wrist terminal device 1 receives the arrival notification, the mail number, the mail sender and the mail text of the e-mail (Step S1).

While the user is not swinging his/her arm by jogging or the like (Motion State (2) not detected) (Step T1: No), the mail notification is made by means of ringtone such as melody, vibration or the like (Step T3). Then, in response to the user holding up his/her arm to look at the wrist terminal device 1 while staying still (Motion State (1) detected) (Step T4: Yes), the mail sender is displayed on the upper part of the display 110 while an ordinary watch image is displayed on the lower part (Step T5, FIG. 9C).

Thereafter, in response to the user performing a touch operation on the display 110 (Step T6: Yes, FIG. 9D), the mail text (e.g. “Good morning.”) is displayed on the upper part of the display 110 in a horizontally scrollable manner while an ordinary watch image is displayed on the lower part (Step T8, FIG. 9E).

Thereafter, in response to the user putting down his/her arm (Motion State (4) detected) (Step T9: Yes), the display 110 is turned off (Step T16, FIG. 9F).

Thereafter, in response to the user taking out the communications terminal device 2 (Step U4: Yes), a mail software is launched to display the mail text of the e-mail that was previously displayed on the wrist terminal device 1 on the display 210 in a manner that distinguishes the displayed part from the undisplayed part (Step U5, FIG. 9G).

After the user has operated to exit the browsing on the communications terminal device 2, in response to the user holding up his/her arm to look at the wrist terminal device 1 again while staying still (Motion State (1) detected) (Step S5: Yes), the continuation of the previously displayed part of the mail text is displayed on the upper part of the display 110 in a horizontally scrollable manner while an ordinary watch image is displayed on the lower part (Step S6, FIG. 9H).

### Operation Example 3

First, when the communications terminal device 2 receives an e-mail from a mail server (Step U1, FIG. 10A), it sends arrival notification, the mail number, the mail sender and the mail text of the e-mail to the wrist terminal device 1 (Step U2, FIG. 10B). In response, the wrist terminal device 1 receives the arrival notification, the mail number, the mail sender and the mail text of the e-mail (Step S1).

While the user is not swinging his/her arm by jogging or the like (Motion State (2) not detected) (Step T1: No), the mail notification is made by means of ringtone such as melody, vibration or the like (Step T3). Then, in response to the user holding up his/her arm to look at the wrist terminal device 1 while staying still (Motion State (1) detected) (Step T4: Yes), the mail sender is displayed on the upper part of the display 110 while an ordinary watch image is displayed on the lower part (Step T5, FIG. 10C).

In response to the user keeping his/her arm up to look at the wrist terminal device 1 for a predetermined period of time while staying still (Motion State (1) continues for the predetermined period of time) (Step T7: Yes), the mail text is displayed on the upper part of the display 110 in a horizontally scrollable manner while an ordinary watch image is displayed on the lower part (Step T8, FIG. 10D).

Thereafter, in response to the user putting down his/her arm (Motion State (4) detected) (Step T9: Yes), the display 110 is turned off (Step T16, FIG. 10E).

Thereafter, in response to the user taking out the communications terminal device 2 (Step U4: Yes), a mail software is launched to display the mail text of the previously displayed e-mail on the display 210 in the manner that distinguishes the displayed part from the undisplayed part (Step U5, FIG. 10F).

After the user has operated to exit the browsing on the communications terminal device 2, in response to the user holding up his/her arm to look at the wrist terminal device 1 again while staying still (Motion State (1) detected) (Step S5: Yes), the continuation of the previously displayed part of the mail text is displayed on the upper part of the display in a horizontally scrollable manner while an ordinary watch image is displayed on the lower part (Step S6, FIG. 10G).

According to the above-described embodiment of the present invention, when a wrist terminal device receives an mail arrival notification, it displays the received e-mail on the display in a display style according to the motion state of a user as illustrated in Steps S1 through S8 of FIG. 5 and Steps T1 through T16 of FIG. 6. Therefore, the received e-mail is suitably displayed in a display style according to the motion state of the user without requiring any operation by the user. For example, if a user is jogging, the device detects the jogging state to automatically display the e-mail on the display in a style suitable for jogging without requiring any operation by the user such as gestures. As a result, the user can readily check the e-mail.

Further, as illustrated in Steps T4 through T8 of FIG. 6, FIG. 8D through FIG. 8F, Steps T10 through T13 of FIG. 6 and FIG. 9C through FIG. 9E, in response to detecting the motion state of the user looking at the wrist terminal device for a predetermined period of time, the text of the received e-mail is scrolled on the display. Therefore, the user can readily check the full text of the received e-mail by the scroll.

Further, as illustrated in Steps T10 and T11 of FIG. 6 and FIG. 8C through FIG. 8E, in response to detecting the motion state of the user looking at the wrist terminal device while on the move, the text of the received e-mail is displayed in an enlarged size on the display. Therefore, the user can readily check the text of the e-mail even while on the move.

Further, as illustrated in Steps T10 through T13 of FIG. 6 and FIG. 8C to FIG. 8E, in response to detecting the motion state of the user looking at the wrist terminal device while on the move, the text of the received e-mail is audibly output. Therefore, the user can readily check the text of the e-mail while on the move through the voice without looking at the display.

Further, as illustrated in Steps T9, T14 through T16 of FIG. 6, FIG. 8D through FIG. 8G, FIG. 9C through FIG. 9F and FIG. 10C through FIG. 10E, after detecting the motion state of looking at the wrist terminal device, in response to detecting the motion state of the user putting down his/her arm, the device stops displaying the mail text on the display. This allows for energy saving by avoiding uselessly displaying the e-mail on the display based on the determination as to whether the user looks at the display.

Further, as illustrated in Steps T9, T14 through T16 of FIG. 6, Steps S3 and S4 of FIG. 5, after detecting the motion state of putting down his/her arm, the previously displayed part of the e-mail that was previously displayed on the display is sent to the communications terminal device in a manner that distinguishes the displayed part from the undisplayed part. Therefore, if a user reads an e-mail halfway in the wrist terminal device and then resumes reading it on the communications terminal device later, the user does not have to reread it from the beginning but can promptly start reading it from the continuation of the half-read e-mail.

Further, as illustrated in Steps T9, T14 through T16 of FIG. 6, Steps S5 and S6 of FIG. 5, FIG. 8G through FIG. 8I, FIG. 9F through FIG. 9H and FIG. 10E through FIG. 10G, after detecting the motion state of putting down his/her arm, in response to detecting the motion state of the user looking at the wrist terminal device again, the undisplayed part, i.e. the part other than the previously displayed part, of the previously displayed e-mail is displayed on the display of the wrist terminal apparatus. Therefore, if a user reads an e-mail halfway in the wrist terminal device and then resumes reading it on the wrist terminal device again, the user does not have to reread it from the beginning, but can promptly start reading it from the continuation of the half-read e-mail.

It should be understood that changes and modifications may be made in the detailed configurations and operations of the components of the wrist terminal device and communications terminal device according to the above-described embodiment without departing from the spirit of the present invention. Specifically, although an e-mail is described as an example of a message (information) in the above embodiments, the present invention can also be adopted to, for example, an online chat or the like, where one can transmit/receive messages to/from a plurality of persons on a real-time basis. Also, in addition to the text data, the information can be image data of character or icon, or a face mark that presents information such as “Yes”, “No”, “Good Job” or “Don't Mind”.

While the embodiment of the present invention is described, the scope of the present invention is not intended to be limited to the above-described embodiment, but is defined by the scope of the claims including the full scope of their equivalents.

What is claimed is:

1. A wrist terminal device configured to be worn around a wrist of a user, comprising:
a motion state detecting unit which detects a motion state of the user;
a receiving unit which receives message arrival notification and a message from a communications terminal device;
a display unit which displays the message received by the receiving unit; and
a motion-responsive display control unit which controls the display unit to display the received message in a display style according to the motion state of the user detected by the motion state detecting unit in response to the receiving unit receiving the message arrival notification and the message.

2. The wrist terminal device according to claim 1,
wherein the message arrival notification is mail arrival notification and the message is an e-mail, and
wherein the motion-responsive display control unit controls the display unit to scroll a text of the received e-mail in response to detecting the motion state of the user looking at the wrist terminal device for a predetermined period of time.

3. The wrist terminal device according to claim 2,
wherein the motion-responsive display control unit controls the display unit to display a text of the received e-mail in an enlarged size in response to detecting the motion state of the user looking at the wrist terminal device while on a move.

4. The wrist terminal device according to claim 2, further comprising:
a voice output unit which audibly outputs a text of the received e-mail in response to detecting the motion state of the user looking at the wrist terminal device while on a move.

5. The wrist terminal device according to claim 2,
wherein after detecting the motion state of the user looking at the wrist terminal device, in response to detecting the motion state of the user putting down an arm, the motion-responsive display control unit controls the display unit to stop displaying the text of the received e-mail.

6. The wrist terminal device according to claim 5, further comprising:
a displayed-part sending unit which sends a previously displayed part of the e-mail that was displayed on the display unit last time to the communications terminal device in a distinguishable manner from an undisplayed part of the e-mail after detecting the motion state of the user putting down his/her arm.

7. The wrist terminal device according to claim 5,
wherein after detecting the motion state of the user putting down his/her arm, in response to detecting the motion state of the user looking at the wrist terminal device again, the motion-responsive display control unit controls the display unit to display an undisplayed part other than the displayed part of the e-mail that was displayed on the display unit last time.

8. The communications terminal device that communicates with the wrist terminal device of claim 6, comprising:
an undisplayed-part-distinguishably-display control unit which displays the e-mail sent from the displayed-part sending unit of the wrist terminal device in a manner that distinguishes the undisplayed part from the previously displayed part of the e-mail that was displayed on the wrist terminal device.

9. A terminal device configured to be worn by a user, comprising:
an information receiving unit which receives information from a communications terminal device;
a motion state detecting unit which detects a motion state of the user;
a display unit which displays the information received from the communications terminal device;
a first-motion display control unit which controls the display unit to display a part of the received information according to a first motion state of the user detected by the motion state detecting unit;
a second-motion display control unit which controls the display unit to stop displaying the received information according to a second motion state of the user detected by the motion state detecting unit, after the control of the first-motion display control unit is performed; and
an undisplay identifier sending unit which sends a previously displayed part of the received information to the communications terminal device in a distinguishable manner from an undisplayed part of the e-mail when the control of the second-motion display control unit is performed.

10. The terminal device according to claim 9,
wherein the terminal device is a wrist terminal device configured to be worn around a wrist of the user,
the first motion state of the user is a motion state of the user looking at the terminal device, and
the second motion state of the user is a motion state of the user putting down an arm.

11. A display control method of a terminal device that communicates with a communications terminal device, comprising the steps of:
detecting a motion state of a user;
receiving message arrival notification and a message from the communications terminal device; and
displaying the received message,
wherein in response to receiving the message arrival notification and the message, the step of displaying the received message is performed in a display style according to the detected motion state of the user.

12. A display control method of a terminal device configured to be worn by a user, comprising the steps of:
receiving information from a communications terminal device;
detecting a motion state of the user;
displaying the received information;
performing control to display a part of the received information according to a detected first motion state of the user;
performing control to stop displaying the received information according to a detected second motion state of the user; and
sending a previously displayed part of the received information to the communications terminal device in a distinguishable manner from an undisplayed part of the e-mail when the control to stop displaying the received information is performed.

13. A non-transitory computer readable storage medium having a display control program that makes a computer function as:
a motion state detecting unit which detects a motion state of a user;
a receiving unit which receives message arrival notification and a message from a communications terminal device;
a display unit which displays the message received by the receiving unit; and
a motion-responsive display control unit which controls the display unit to display the received message in a display style according to the motion state of the user detected by the motion state detecting unit in response to the receiving unit receiving the message arrival notification and the message.

14. A non-transitory computer readable storage medium having a display control program that makes a computer of a terminal device configured to be worn by a user function as:
an information receiving unit which receives information from a communications terminal device;
a motion state detecting unit which detects a motion state of the user;
a display unit which displays the information received from the communications terminal device;
a first-motion display control unit which controls the display unit to control the display unit to display a part of the received information according to a first motion state of the user detected by the motion state detecting unit;
a second-motion display control unit which controls the display unit to stop displaying the received information according to a second motion state of the user detected by the motion state detecting unit, after the control of the first-motion display control unit is performed; and
an undisplay identifier sending unit which sends a previously displayed part of the received information to the communications terminal device in a distinguishable manner from an undisplayed part of the e-mail when the control of the second-motion display control unit is performed.
